(19) United States
(12) Patent Application Publication
(10) Pub. No.: US 2007/0299377 A1
(43) Pub. Date: Dec. 27, 2007

(54) Chair-Type Massage Machine and Massage Mechanism

(76) Inventor: Satoru Shiraishi, Osaka (JP)

Correspondence Address: BIRCH STEWART KOLASCH & BIRCH, PO BOX 747, FALLS CHURCH, VA, 22040-0747, US

(21) Appl. No.: 11/665,220

(22) PCT Filed: Oct. 5, 2005
(86) PCT No.: PCT/JP05/18410

§ 371 Date: Apr. 12, 2007

(30) Foreign Application Priority Data
Nov. 30, 2004 (JP) 2004-347441

(51) Int. Cl. A61H 7/00; A61H 15/00

(52) U.S. Cl. 601/98; 601/112; 601/134; 601/84

(57) ABSTRACT

The present invention provides a chair-type massage machine for protruding massage members having massage heads and swing arms for supporting the heads farther forward than normal massage operation positions.

The chair-type massage machine includes an upwardly/downwardly-moving base 71 provided to be movable in an upward/downward direction in a back rest portion 63 and a mechanism portion 70 provided to a front face of the upwardly/downwardly-moving base 71 through a support frame 3. A lower end portion of the support frame 3 is coupled to the upwardly/downwardly-moving base 71 through a swinging pivot portion 100 for swinging forward and backward and a protruding/withdrawing mechanism 105 for moving the support frame 3 forward and backward is provided between the support frame 3 and the upwardly/downwardly-moving base 71.

### TECHNICAL FIELD

The present invention relates to a chair-type massage machine and massage mechanism.

### BACKGROUND ART

Currently, among chair-type massage chairs, a dominating configuration is one in which four massage heads provided in a back rest portion of a chair carry out various massage operations, respectively, while moving up and down on a back of a user's body. Among such configurations, there is a known technique in which the massage heads protrude farther forward than normal massage operation positions as necessary so as to switch between high and low massage intensity levels or to obtain satisfactory massage effects by causing the massage heads to fit shoulders of a user (see Patent Documents 1 to 3 and the like, for example).

What the above known massage head forward-protruding configurations have in common is that a swing arm for supporting the massage heads is formed to be long and that a swinging angle of the arm is made greater than that during a normal massage operation. Incidentally, there are various driving methods themselves for increasing the swinging angle of the swing arm.

Patent Document 1: Japanese Laid-Open Patent Publication No. 2004-202010

Patent Document 2: Japanese Laid-Open Patent Publication No. 2004-16501

Patent Document 3: Japanese Laid-Open Patent Publication No. 2002-159549

### DISCLOSURE OF INVENTION

### Problems to be Solved by the Invention

As described above, in the known massage head forward-protruding configuration, the swing arms for supporting the massage heads need be formed to be long, and therefore, rigidity of the swing arm itself may become insufficient. If the rigidity of the swing arm is insufficient, the swing arm itself shakes or bends and a movement of a root of the arm (movement from a driving side) is not sufficiently transmitted as swinging and the like of the massage heads to thereby reduce the massage effects by just that much.

Furthermore, if the swing arms are long, a vertical dimension of an apparatus increases by just that much, which results in increase in size of the apparatus.

The present invention has been made with the above circumstances in view and it is an object of the invention to provide a chair-type massage machine and massage mechanism in which, in providing a mechanism for protruding massage members including massage heads and swing arms for supporting the massage heads farther forward than normal massage operation positions, it is possible to impart rigidity to the massage members and to efficiently obtain various massage effects by the massage members protruding forward.

Moreover, it is an object of the invention to provide a chair-type massage machine and massage mechanism in which, in increasing the rigidity of the massage members, it is possible to suppress increase in size of the apparatus.

### Means for Solving the Problems

To achieve the above objects, the present invention takes the following measures.

In other words, a chair-type massage machine according to the invention includes: a seat portion; a back rest portion provided to a rear portion of the seat portion; an upwardly/downwardly-moving base provided to be movable in an upward/downward direction in the back rest portion; and a mechanism portion provided to a front face of the upwardly/downwardly-moving base through a support frame, wherein the mechanism portion has a pair of left and right massage members and a driving mechanism for properly transmitting massage operations to both the massage members.

A lower end portion of the support frame is coupled to the upwardly/downwardly-moving base through a swinging pivot portion such that an upper end side of the support frame is retained swinging forward and backward, and a protruding/withdrawing mechanism for moving the support frame forward and backward is provided between the support frame and the upwardly/downwardly-moving base.

With the above configuration in which the mechanism portion swings forward and backward together with the support frame supporting the mechanism portion, so that the massage members protrude and withdraw, it is unnecessary to employ shapes of the massage members for reducing rigidity of the members. In other words, while maintaining sufficient rigidity of the massage members, it is possible to protrude the members farther forward than the normal massage operation positions. Therefore, it is possible to efficiently obtain various massage effects by the massage members protruding forward.

Each of the massage members may be provided with the massage heads disposed while leaving a predetermined space between the massage heads in the upward/downward direction.

The protruding/withdrawing mechanism may include: a guide rail formed to protrude forward from the upwardly/downwardly-moving base; a slider which is engaged for sliding forward and backward in the guide rail and on which the support frame is pivoted; an eccentric cam provided with its outer peripheral face in contact with a rear face portion of the slider; and a protruding/withdrawing driving device for rotating the eccentric cam.

By employing such a configuration, it is possible to adjust an amount of pushing the slider by the eccentric cam, i.e., a swinging angle of the support frame retained by the slider by adjusting a rotation angle of the eccentric cam. As a result, it becomes possible to adjust a degree to which the massage members provided through the support frame protrude in a forward-backward direction.

Moreover, by continuously rotating the eccentric cam, it is possible to cause the massage members to carry out continuous protruding/withdrawing operations. Strokes of protrusion and withdrawal of the massage members in this case may be longer than those in case of moving the massage members forward and backward by the mechanism portion due to characteristics of the employed mechanism. Therefore, depending on which of the continuous operations of this protruding/withdrawing mechanism and actuation of the mechanism portion is employed, it is possible to switch between high and low intensity levels of a tapping massage operation or acupressure massage operation.

With the configuration using the eccentric cam, quicker protrusion and withdrawal can be obtained than those when other structures such as a fluid-pressure cylinder are employed, and the movements can be used as the tapping massage operations and the like. Moreover, there is an advantage that the configuration is simplified.

The mechanism portion includes a first operating mechanism for carrying out a kneading massage operation and a second operating mechanism for carrying out a tapping or acupressure massage operation.

The first operating mechanism includes: a first rotary shaft bridged in a lateral direction; a first driving body for driving the first rotary shaft for rotation; a pair of left and right cam members, fixed in vicinities of opposite ends of the first rotary shaft, and having cam faces inclined in opposite directions in the lateral direction; a pair of left and right massage members provided for rotation with respect to each other to the first rotary shaft through the left and right cam members; and bracing members engaged with the respective massage members so as to restrict rotation of both the massage members with rotation of the first rotary shaft and provided to be movable to follow turning of the massage members about the first rotary shaft.

The second operating mechanism includes: a second rotary shaft provided parallel to the first rotary shaft; a second driving body for driving the second rotary shaft for rotation; cam disks provided in vicinities of opposite ends of the second rotary shaft; and connecting rods having one end portions coupled to the cam disks so as to oscillate as the cam disks rotate eccentrically and the other end portions coupled to the bracing members.

With such a configuration, by swinging opposite end portions of the left and right swing arms in opposite directions to each other by the first operating mechanism, it is possible to carry out the kneading massage operations with the massage heads. By reciprocating the swing arms about an axis of the first rotary shaft by the second operating mechanism, it is possible to carry out the tapping massage operations and acupressure massage operations with the massage heads.

If the bracing members or the second operating mechanism are (is) fixed, turning of the swing arms about the first rotary shaft is restricted to make it difficult to bring all the massage heads in uniform contact with the user's body. Therefore, any of the massage heads may not be in contact with the user's body and intensity of kneading or tapping may be reduced partially.

In the above configuration, however, the bracing members and the second operating mechanism are movable. Therefore, if the user's body is pressed against the massage heads provided to the opposite end portions of the swing arms, the bracing members and the second operating mechanism move properly to allow turning of the swing arms. As a result, the respective massage heads come in contact with the user's body with substantially equal pressures. Therefore, the user to be massaged can get an effective massage.

When the first driving body is actuated to rotate the first rotary shaft, the first operating mechanism carries out swinging motions in such manners that the end portions on the same side of the left and right massage members approach each other while the end portions on the other side move away from each other and that the end portions on the same side move away from each other while the end portions on the other side approach each other through the cam faces inclined in opposite directions to each other. Thus, it is possible to carry out the kneading massage.

In the second operating mechanism, the second rotary shaft rotates to push and pull the connecting rods through the cam disks and the swing arms engaged with the bracing members coupled to the connecting rods reciprocate about the first rotary shaft. By utilizing this reciprocation, it is possible to carry out the tapping massage.

A massage mechanism according to the invention includes a fixed base and a mechanism portion provided to a front face of the fixed base through a support frame, wherein the mechanism portion includes a pair of left and right massage members and a driving mechanism for properly transmitting massage operations to both the massage members. A lower end portion of the support frame is coupled to the fixed base through a swinging pivot portion such that an upper end side of the support frame is retained for swinging forward and backward, and a protruding/withdrawing mechanism for moving the support frame forward and backward is provided between the support frame and the fixed base.

### EFFECTS OF THE INVENTION

With the chair-type massage machine and the massage mechanism according to the invention, in providing a mechanism for protruding the massage members including the massage heads and the swing arms for supporting the heads farther forward than the normal massage operation positions, it is possible to provide rigidity to the massage members and therefore it is possible to efficiently obtain various massage effects by the massage members protruding forward.

In increasing the rigidity of the massage members as described above, it is possible to avoid increase in size of the apparatus.

### BRIEF DESCRIPTION OF THE DRAWINGS

FIG. 1 is a general perspective view of an assembled form of an upwardly/downwardly-moving base, support frame, and mechanism portion.

FIG. 2 is a left side view corresponding to FIG. 1.

FIG. 3 is a perspective view of a protruding/withdrawing mechanism.

FIG. 4 is a plan view of the mechanism portion in half section and seen from above.

FIG. 5 is a general plan view of the assembled form of the upwardly/downwardly-moving base, the support frame, and the mechanism portion seen from above.

FIG. 6 is a perspective view of the mechanism portion seen diagonally from below, with one of support brackets omitted.

FIG. 7 is a side view of a second operating mechanism.

FIG. 8 is a side view of the second operating mechanism.

FIG. 9 is a cutaway front view of the second operating mechanism.

FIG. 10 is an exploded perspective view of the support frame and a guide supporter.

FIG. 11 is a side view of an embodiment of a chair-type massage machine according to the present invention.

### DESCRIPTION OF THE REFERENCE NUMERALS

1 chair-type massage machine
3 support frame
6 massage member
5 first rotary shaft
7 first operating mechanism
8 second operating mechanism
11 massage head
14 cam member
14A cam face
25 first driving body
27 second rotary shaft
28 cam disk
29 connecting rod
30 bracing member
40 second driving body
62 seat portion
63 back rest portion
71 upwardly/downwardly-moving base
70 mechanism portion
100 swinging pivot portion
105 protruding/withdrawing mechanism
115 guide rail
116 slider
111 eccentric cam
113 protruding/withdrawing driving device

### BEST MODE FOR CARRYING OUT THE INVENTION

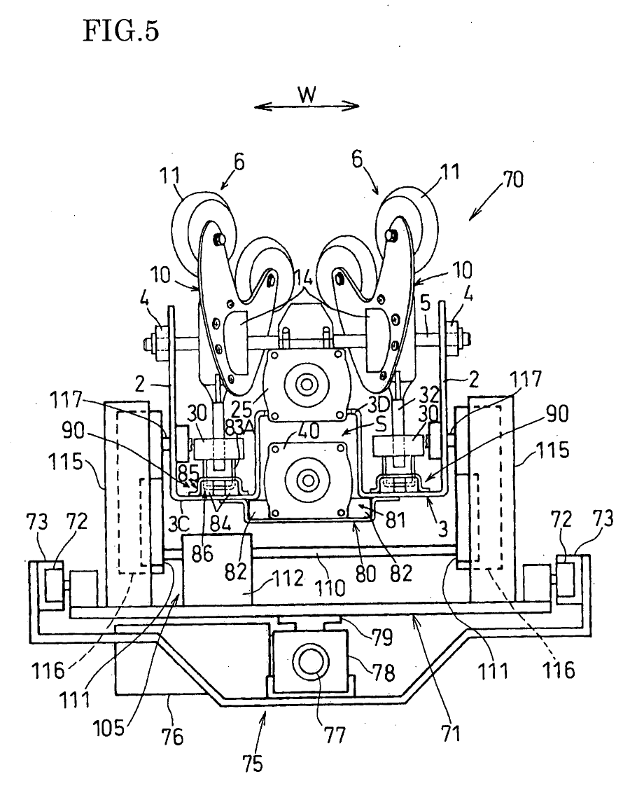

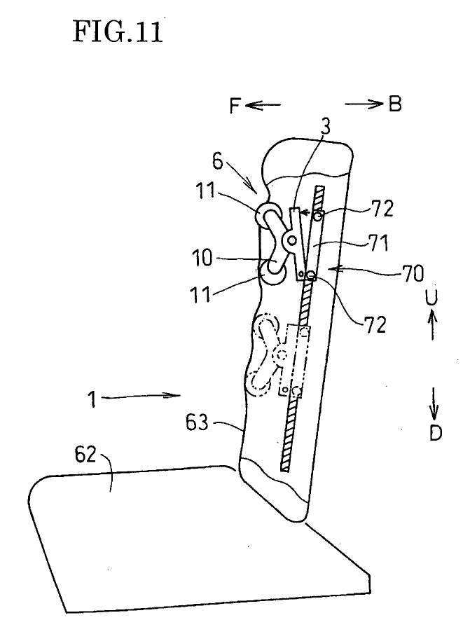

An embodiment of the present invention will be described below based on the drawings. Regarding directions in the description, a direction F is a forward direction and a direction B is a backward direction in FIG. 11. A direction U is an upward direction and a direction D is a downward direction in FIG. 11. A lateral direction (width direction) is a direction W in FIG. 5.

FIG. 11 shows an embodiment of a chair-type massage machine 1 according to the invention. This chair-type massage machine 1 includes a seat portion 62 and a back rest portion 63 formed to rise from a rear portion of the seat portion 62. A mechanism portion 70 is housed to be movable in the upward/downward direction in the back rest portion 63.

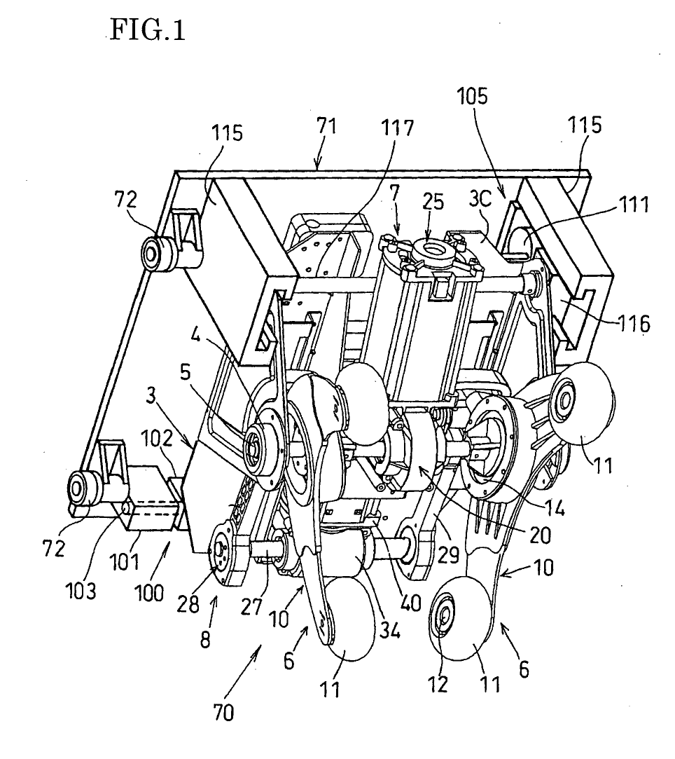

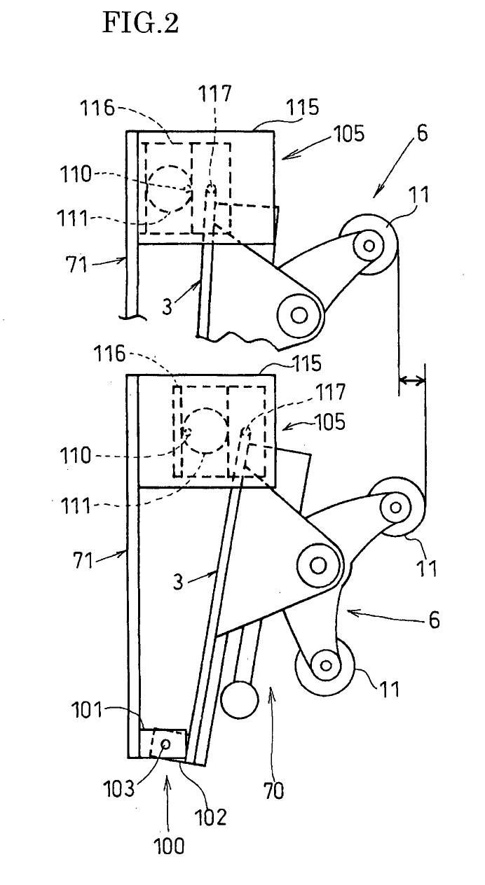

As shown in FIGS. 1, 2, and 5, the mechanism portion 70 is provided to the support frame 3 and the support frame 3 is provided so that its plane becomes parallel to a front face portion of an upwardly/downwardly-moving base 71.

On left and right opposite sides of an upper portion and lower portion of this upwardly/downwardly-moving base 71, guide rollers 72 are provided with their rotation axes oriented in the lateral direction. These guide rollers 72 are guided to be able to move up and down along guide rail 73 mounted in the back rest portion 63 with their longitudinal directions oriented in the upward/downward direction. In this state, the upwardly/downwardly-moving base 71 properly moves up and down when driven by a moving means 75. In this way, a user to be massaged and sitting on the seat portion 62 with his/her back pressed against the back rest portion 63 can get a massage in a large area from a back of his/her head to back and lower back.

The moving means 75 shown in FIG. 5 is an example of the means. The respective guide rollers 72 are engaged with the guide rails 73 having angular U sectional shapes which the guide rollers 72 face on left and right sides. A screw shaft 77 which can be driven for rotation by an elevating motor 76 is provided between the opposite guide rails 73 and a nut member 78 screwed over the screw shaft 77 is coupled to the upwardly/downwardly-moving base 71 through a coupling member 79. Therefore, if the elevating motor 76 drives the screw shaft 77 for rotation, the nut member 78 is screw-fed upward or downward and the upwardly/downwardly-moving base 71 moves up and down with this screw-feeding. As a result, the mechanism portion 70 moves up and down with the support frame 3 in such a manner as to accompany the upwardly/downwardly-moving base 71.

The support frame 3 is coupled to the upwardly/downwardly-moving base 71 through swinging pivot portions 100 provided to a lower end portion of the support frame 3 and the support frame 3 is retained in such a state that an upper end side of the frame can swing in a forward-backward direction around the swinging pivot portions 100 as fulcrums. A pair of left and right swinging pivot portions 100 having coaxial fulcrum axes are provided.

Each of the swinging pivot portions 100 includes a hinge block 101 provided on a front face side of the upwardly/downwardly-moving base 71, hinge block 102 provided on a back face side of the support frame 3 to be adjacent to an inner side in the lateral direction of the hinge block 101, and pivot 103 connecting these hinge blocks 101, 102. The pivot 103 may be fixed to either one of the hinge blocks 101, 102 or may be rotatably inserted through both the hinge blocks 101, 102 while being properly prevented from withdrawing.

Between the upwardly/downwardly-moving base 71 and the support frame 3, a protruding/withdrawing mechanism 105 for moving the support frame 3 forward and backward with respect to the upwardly/downwardly-moving base 71 is provided.

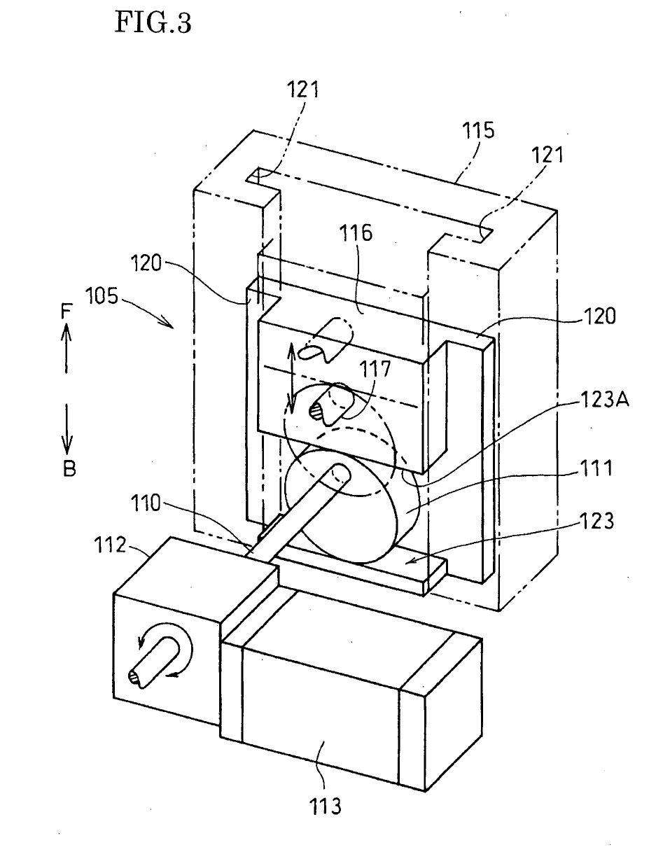

In the present embodiment, the protruding/withdrawing mechanism 105 (see also FIG. 3) employs a configuration in which a rotary shaft 110 with its axis oriented in the lateral direction eccentrically rotates eccentric cams 111. A locus of an outer peripheral face of each eccentric cam 111 protrudes and withdraws in the forward-backward direction at this time, which is utilized to directly or indirectly press a back face of the support frame 3 to thereby move the support frame 3 forward and backward.

One eccentric cam 111 is provided on each of left and right opposite sides close to the upper end portion of the support frame 3. Both the eccentric cams 111 are coupled by the one rotary shaft 110, a reducer 112 is provided at a midpoint of this rotary shaft 110, and a protruding/withdrawing driving device 113 formed of a motor or the like that can rotate normally and reversely drives the reducer 112. Needless to say, the left and right eccentric cams 111 are eccentric in the same direction and rotate (rotate eccentrically) together with the rotary shaft 110.

For smooth and stable forward and backward movements of the support frame 3, guide rails 115 protruding forward from the upwardly/downwardly-moving base 71 are provided at left and right opposite side portions of the upwardly/downwardly-moving base 71 corresponding to the upper end portion of the support frame 3. Sliders 116 are provided to the left and right guide rails 115, respectively, to be able to slide forward and backward. The support frame 3 is connected to the left and right sliders 116.

As shown in FIG. 1, the sliders 116 and the support frame 3 are connected by bridging a support shaft 117 between the left and right sliders 116 so that the support shaft 117 penetrates the upper end portions of the support frame 3 in a skewering manner. In FIG. 5, a manner in which the support shaft 117 cuts across in front of the support frame 3 is not shown. Where the support shaft 117 penetrates the support frame 3, they are rotatable with respect to each other.

The sliders 116 and the guide rails 115 are made of resin (Duracon or the like) with good lubricity. Each of the sliders 116 has a pair of left and right slider chips 120 jutting out like wings and sideways in opposite directions with respect to the sliding direction of the slider 116. On the other hand, each of the guide rails 115 has two opposed grooves 121 for holding the opposite slider chips 120 of the slider 116 from opposite outer sides. Therefore, as a result of this configuration, the slider 116 can stably slide without wobbling.

Moreover, in opposed faces of the left and right sliders 116, cam holes 123 in which the eccentric cams 111 are fitted are formed in recessed manners. Each of the cam holes 123 has such a width as to restrain (come in contact with) the eccentric cam 111 diametrically in the forward-backward direction (swinging direction of the support frame 3) and to allow eccentric rotation of the eccentric cam 111 in a direction orthogonal to the forward-backward direction (upward/downward direction of the support frame 3). In this way, it is possible to extract only a forward-backward operation component (in directions F and B) from the eccentric rotation of the eccentric cam 111.

Because such a cam hole 123 is formed, the slider 116 is regulated only by a rotation angle of the eccentric cam 111 and the slider 116 does not slide along the guide rail 115 unless the eccentric cam 111 rotates.

However, it is only essential that the eccentric cam 111 push out the slider 116 forward. Therefore, the eccentric cam 111 only needs to come in contact with at least a rear face of the slider 116 (corresponding to a face 123A near the support frame 3 in the cam hole 123 and facing the upwardly/downwardly-moving base 71). In this case, however, it is necessary to provide a spring for always biasing the slider 116 close to the upwardly/downwardly-moving base 71.

As the above-described protruding/withdrawing driving device 113, it is preferable to employ a device that can not only rotate normally and reversely but also rotate continuously, turn partially, and be regulated in speed. Especially regarding partial turning, a two-position control for selectively repeating a turn and stop at every 180° and a turn through an arbitrary angle (a minute angle or a wide angle over 180°) according to a desired operation of the user to be massaged are convenient.

The guide rail 115 and slider 116 are not limited to those combined with the eccentric cam 111. The guide rail 115, slider 116, and eccentric cam 111 may be provided independently in separate positions. The guide rail 115 and slider 116 are not absolute necessities and may be omitted. It is also possible to provide the guide rails 115 to the support frame 3 and to provide the sliders 116 to the upwardly/downwardly-moving base 71.

It is also possible to provide only one eccentric cam 111. It is possible to provide the eccentric cam 111 to the support frame 3 and to bring the outer peripheral face Qf the eccentric cam 111 in direct or indirect contact with the upwardly/downwardly-moving base 71. Moreover, as the protruding/withdrawing mechanism 105, it is possible to employ not only one using the eccentric cam 111 but also a fluid-pressure cylinder or other various mechanisms.

As shown in FIGS. 1 and 4 to 10, the mechanism portion 70 includes the support frame 3 having a pair of left and right support brackets 2 with a predetermined interval to each other, a first rotary shaft 5 rotatably bridged between the brackets 2 of the support frame 3 through bearings 4, 4, a pair of left and right massage members 6 provided at opposite end portions of the first rotary shaft 5, and a first operating mechanism 7 and second operating mechanism 8 for causing these massage members 6 to carry out various massage operations.

As shown in FIGS. 5, 8, and 10, in the support frame 3, a mount table 3D bulging forward in a box shape is provided at a central portion of a base plate 3C connecting the left and right support brackets 2. In the base plate 3C, notch-shaped spaces 3E are formed above and below the mount table 3D.

Each of the massage members 6 includes a swing arm 10 and massage heads 11 provided to the swing arm 10. The swing arm 10 includes an intermediate portion 10A which the first rotary shaft 5 penetrates to be rotatable with respect to the intermediate portion 10A and a pair of upper and lower arm portions 10B protruding up and down in diagonally forward directions from the intermediate portion 10A. Each of tip end portions (upper end portions and lower end portions of the swing arm 10) of the upper and lower arm portions 10B has the massage head 11. In other words, four massage heads 11 are provided in total.

The massage head 11 is formed in a disk shape and a central portion of the head 11 is rotatably mounted to the upper end portion or the lower end portion of the swing arm 10 through a mounting pin 12.

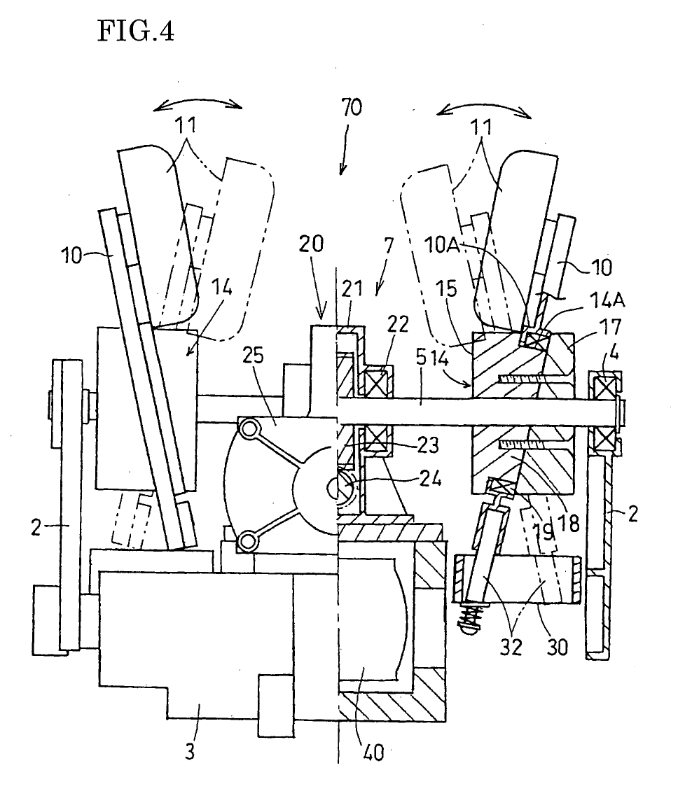

Near opposite ends of the first rotary shaft 5, a pair of left and right cam members 14 having cam faces 14A inclined with respect to an axis of the first rotary shaft 5 is provided. As shown in FIG. 4, the cam member 14 includes a first boss portion 15 fixed to the first rotary shaft 5 to be rotatable with the first rotary shaft 5 and a second boss portion 17 coupled to the first boss portion 15 by using screws. Between both the boss portions, a slant cylindrical portion 18 inclined with respect to the axis of the first rotary shaft 5 is provided and an outer peripheral face of the slant cylindrical portion 18 forms the cam face 14A. The respective cam faces 14A of the left and right cam members 14 are inclined in opposite directions to each other.

A bearing 19 is fitted over the cam face 14A and the bearing 19 is fitted in a fitting hole formed in the intermediate portion 10A of the swing arm 10.

In front of the mount table 3D of the support frame 3, a first reducer 20 is provided. The above-described first rotary shaft 5 laterally penetrates the first reducer 20. The first reducer 20 includes a shaft bearing 22 such as a bearing and bushing for supporting the first rotary shaft 5 for rotation in a gear case 21, worm wheel 23 fixed to the first rotary shaft 5, and worm 24 engaged with the worm wheel 23. To the worm 24, an output shaft of a first driving body 25 formed of a motor that can rotate normally and reversely and provided above the gear case 21 is connected.

Therefore, if the first driving body 25 rotates the first rotary shaft 5, the pair of left and right swing arms 10 swing along the cam faces 14A of the cam members 14 rotating with the first rotary shaft 5. Because the cam faces 14A of the left and right cam members 14 are inclined in opposite directions to each other, the left and right opposite swing arms 10 repeat operations in such manners that the lower massage heads 11 move away from each other when the upper massage heads 11 approach each other and that the lower massage heads 11 approach each other when the upper massage heads 11 move away from each other.

In this way, it is possible to obtain kneading massage operations for pinching a part of the user's body between the left and right opposite massage heads 11. The kneading massage operations by the upper massage heads 11 and the lower massage heads 11 are in reverse patterns to each other.

Here, the first driving body 25, first reducer 20, first rotary shaft 5, cam members 14, and the like form a first operating mechanism 7 for causing the massage members 6 to carry out the kneading massage operations.

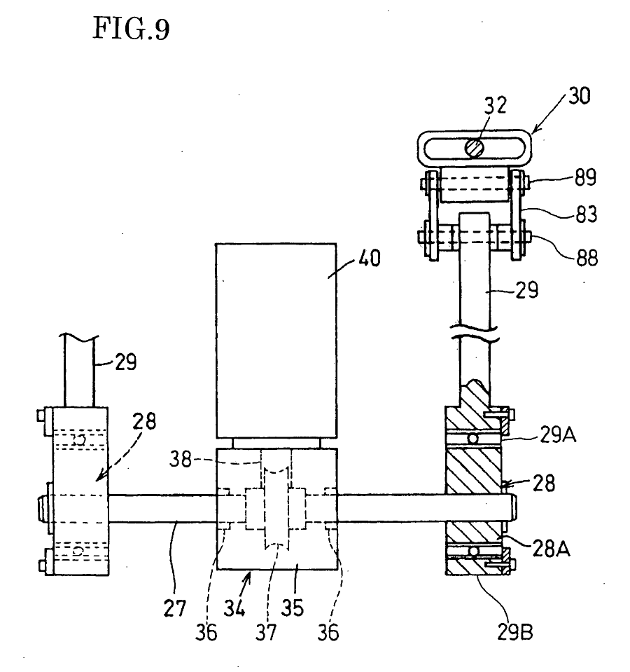

On the lower portion side of the support frame 3, a second rotary shaft 27 with its axial direction oriented in the lateral direction and parallel to the first rotary shaft 5 is bridged. As shown in FIG. 9, at opposite end portions of the second rotary shaft 27, cam disks 28 eccentric with respect to the axis of the shaft 27 are provided to be rotatable with the second rotary shaft 27 (eccentrically rotatable).

Each of the cam disks 28 is coupled to a bracing member 30 through a connecting rod 29. The bracing member 30 is formed in a shape of a box tube penetrating in the forward-backward direction and having an opening that is long in the lateral direction. In the tube of the bracing member 30, an engaging member 32 protruding backward from the intermediate portion 10A of the swing arm 10 is inserted.

Therefore, even if the first rotary shaft 5 rotates, rotation of the swing arm 10 with the shaft 5 is prevented. As shown in FIG. 4, lateral movements of the engaging member 32 attendant on lateral swings of the swing arm 10 by the first operating mechanism 7 are allowed and restricted according to a width of the lateral opening of the bracing member 30.

At a lower end portion of the connecting rod 20, a bearing case 29B in which a shaft bearing 29A such as a bearing and bushing to be fitted over the cam disk 28 is mounted is provided to allow freewheeling of the cam disk 29 with respect to the connecting rod 20.

Between an upper end portion of the connecting rod 29 and the bracing member 30, joint members 83 for allowing slight oscillation of the bracing member 30 are provided. In other words, a coupling pin 88 couples the connecting rod 29 and the joint members 83 in a lateral direction in a skewering manner to pivot the joint members 83 on the connecting rod 29. Moreover, a coupling pin 89 couples the joint members 83 and the bracing member 30 in the lateral direction in a skewering manner to pivot the bracing member 30 on the joint members 83.

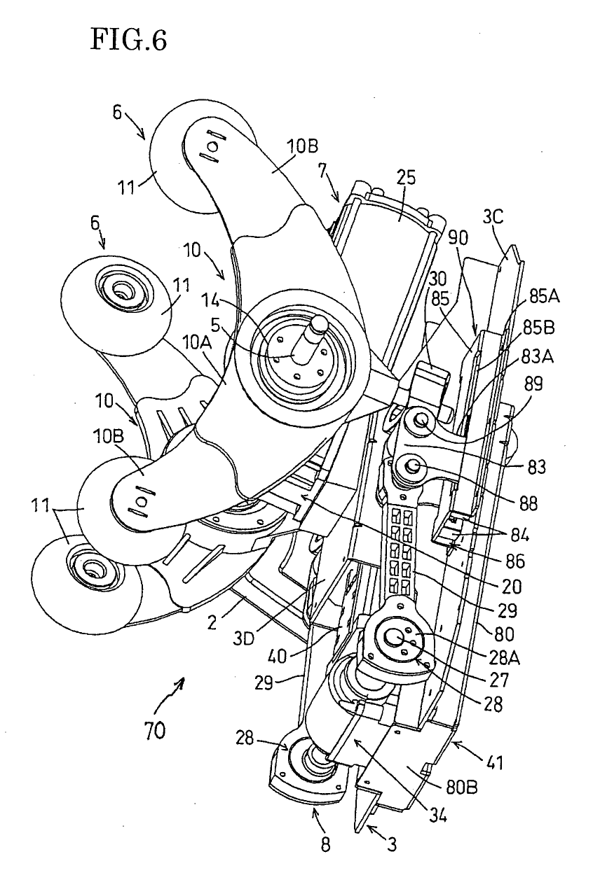

As shown in FIGS. 6, 7, and 8, leg portions 83A are formed to protrude from rear portions of the joint members 83 and the leg portions 83A are provided with sliders 84.

The base plate 3C of the support frame 3 is provided with rail forming frames 85 on left and right opposite sides of the mount table 3D with their longitudinal directions oriented in the upward/downward direction. Each of the rail forming frames 85 is formed in an angular U shape in section. Flange portions 85A are formed to jut out from left and right opposite side edges of the rail forming frame 85 and longitudinal grooves 85B are formed along longitudinal directions of left and right opposite side edge portions of a front face portion of the rail forming frame 85.

Each of these rail forming frames 85 is fixed to the support frame 3 by screwing the flange portions 85A onto the base plate 3C. Thus, between an inner side of the rail forming frame 85 and a surface of the base plate 3C, a guide rail 86 in which the above-described sliders 84 are fitted for sliding is formed. Through the longitudinal grooves 85B in the rail forming frame 85, the leg portions 83A protrude forward from the sliders 84.

These joint members 83, sliders 84, and guide rail 86 form a second guide supporter 90 for retaining the bracing member 30 so that the member 30 can move up and down.

In this way, by supporting the bracing member 30 by the second guide supporter 90 so that the member 30 can move up and down, the bracing member 30 can move smoothly in carrying out tapping massage operations and the like and it is possible to prevent a twist of a portion between the bracing member 30 and the engaging member 32 of the swing arm 10 and detachment of the bracing member 30 from the engaging member 32.

The second rotary shaft 27 penetrates a second reducer 34 in the lateral direction. The second reducer 34 includes shaft bearings 36 such as bearings or bushings for supporting the second rotary shaft 27 so that the shaft 27 can rotate in a gear case 35, a worm wheel 37 fixed to the second rotary shaft 27, and worm 38 engaged with the worm wheel 37 as shown in FIG. 9. Connected to this worm 38 is an output shaft of a second driving body 40 formed of a motor that is provided above the gear case 35 and can rotate normally and reversely.

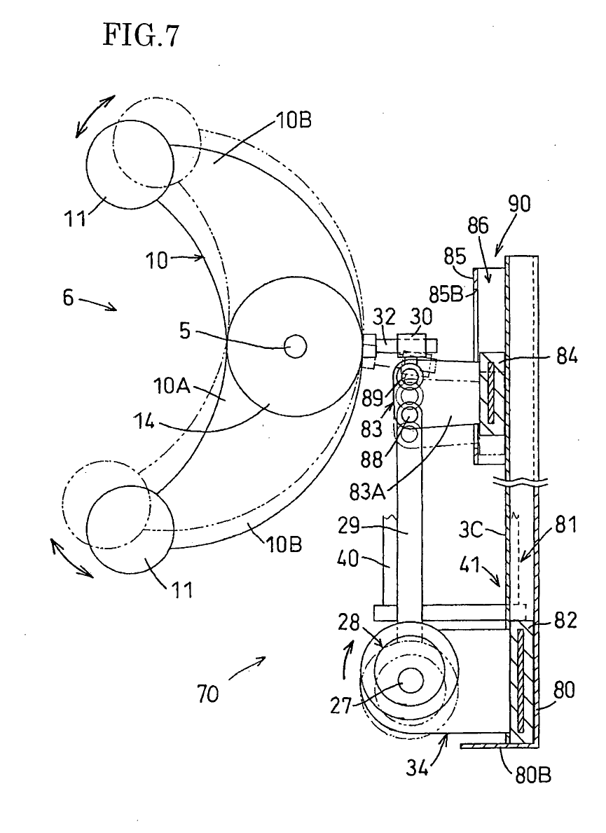

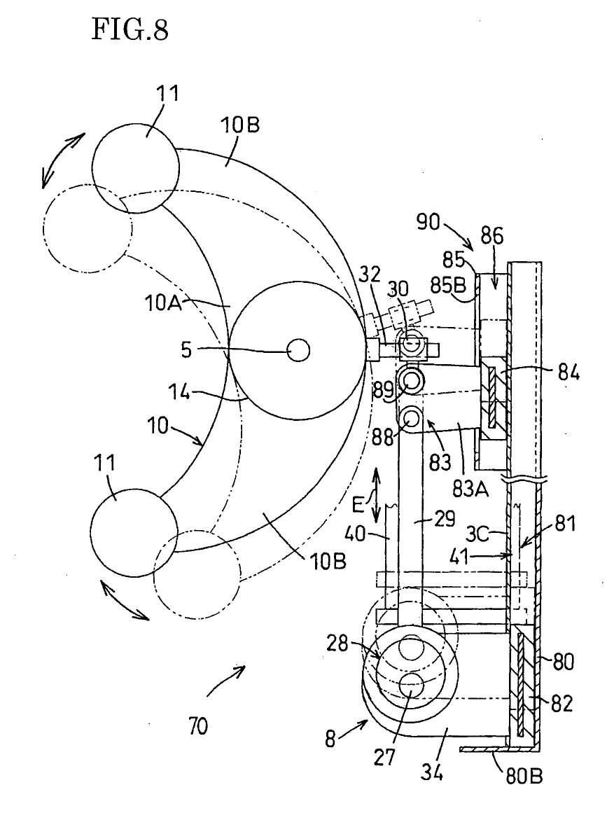

Therefore, if the second driving body 40 rotates the second rotary shaft 27, as shown in FIGS. 7 and 8, the cam disk 28 eccentrically rotates, the connecting rod 29 coupled to the cam disk 28 is pushed up and pulled down, and, as a result, the swing arm 10 swings in a reciprocating manner about the first rotary shaft 5 through the bracing member 30.

At this time, the massage heads 11 provided to upper and lower opposite end portions of the swing arm 10 alternately protrude forward and withdraw. If the second rotary shaft 27 is rotated at a relatively high speed, the user's body cannot follow the protruding/withdrawing motions of the massage heads 11 and therefore the tapping massage operations can be obtained. If rotation of the second rotary shaft 27 is slowed down electrically or mechanically, the user's body follows the protruding/withdrawing motions of the massage heads 11 and the respective massage heads 11 carry out acupressure massage operations in which the massage heads 11 apply pressure to areas of the user's body.

Here, the second driving body 40, second reducer 34, second rotary shaft 27, connecting rods 29, cam disks 28, and the like form the second operating mechanism 8 for causing the massage members 6 to carry out the tapping massage operations and the acupressure massage operations.

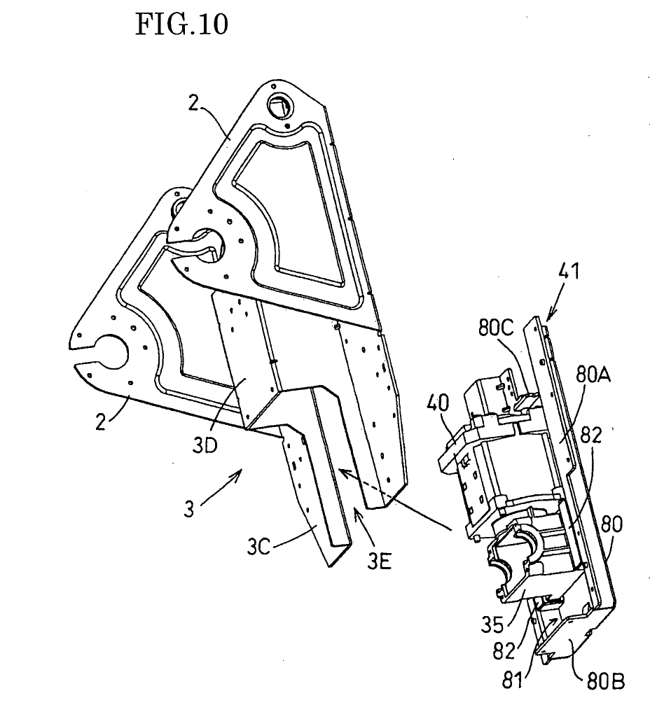

As shown in FIG. 10, the second operating mechanism 8 is supported on the base plate 3C through a guide supporter 41 such that the second operating mechanism 8 is housed in the lower space 3E on the base plate 3C of the support frame 3.

The guide supporter 41 includes a rail forming frame 80 having an angular U shape in section, flange portions 80A formed to jut out from left and right opposite side edges of the rail forming frame 80, and stoppers 80B, 80C provided on opposite end portions in the longitudinal direction of the rail forming frame 80. By screwing these flange portions 80A onto a back face of the base plate 3C of the support frame 3, guide rails 81 (see FIG. 5) are formed between an inner side face of the rail forming frame 80 and the back face of the base plate 3C.

Sliders 82 are slidably retained in the guide rails 81 formed as described above. The sliders 82 are coupled to the gear case 35 of the second reducer 34 and therefore the whole second operating mechanism 8 including the second reducer 34 can move up and down along the guide rails 81. As the second operating mechanism 8 moves up and down, the second driving body 40 passes through an inside space S of the mount table 3D. The stoppers 80B, 80C restrict a range of upward and downward movements of the second operating mechanism 8.

Because the second operating mechanism 8 can move up and down as described above, if external forces are applied to the massage heads 11, e.g., if the user's body is pressed against the massage heads 11, it is possible to turn the swing arms 10 according to curves of the user's body (e.g., an s-shaped curve of his/her back) about the first rotary shaft 5 to thereby bring the respective massage heads 11 in contact with the user's body with substantially equal pressures independently of the massage operations by the first and second operating mechanisms 7, 8.

In other words, as shown in FIG. 8, rotation of each of the swing arms 10 with the first rotary shaft 5 is restricted by the bracing member 30. However, the guide supporter 41 supports the second operating mechanism 8 coupled to the bracing member 30 so that the second operating mechanism 8 can move. Therefore, when the user's body is pressed against the massage heads 11, the second operating mechanism 8 and bracing member 30 move in the upward/downward direction shown with an arrow E so that the swing arm 10 is allowed to turn.

As a result, while the swing arms 10 are mounted to the first rotary shaft 5 and can be caused to carry out the tapping massage operations and the like by the second operating mechanism 8, the swing arms 10 can turn according to the curves of the user's body.

It is possible to switch between actuation of either one of the first driving body 25 and second driving body 40 and simultaneous actuation of the both. In case of the simultaneous actuation of the both, the swing arms 10 reciprocate about the first rotary shaft 5 while swinging in the lateral direction and it becomes possible to carry out the tapping massage while laterally reciprocating the massage heads 11.

As described above specifically, in the chair-type massage machine 1 according to the invention, the mechanism portion 70 for carrying out the kneading massage operations, acupressure massage operations, or tapping massage operations swings forward and backward with the support frame 3 to thereby cause the massage members 6 to protrude and withdraw. Therefore, it is unnecessary to employ shapes of the massage members 6 for reducing rigidity of the massage members 6.

In other words, while maintaining sufficient rigidity of the massage members 6, it is possible to protrude the massage members 6 farther forward than the normal massage operation positions. Therefore, it is possible to efficiently obtain various massage effects by the massage members 6 (massage heads 11) protruding forward.

It is possible to protrude the massage members 6 farther forward than the normal massage operation positions not only in parallel with but also independently of various massage operations by the mechanism portion 70.

The above-described chair-type massage machine 1 includes a massage mechanism inside itself and the mechanism includes a fixed base 71 (corresponding to the above-described upwardly/downwardly-moving base) and mechanism portion 70 provided to a front face of the fixed base 71 through the support frame 3. The mechanism portion 70 includes a pair of left and right massage members 6 and driving mechanisms 7, 8 for properly transmitting massage operations to both the massage members 6. The lower end portion of the support frame 3 is coupled to the fixed base 71 through the swinging pivot portion 100 so that the upper end side of the support frame 3 is retained for swinging forward and backward. The protruding/withdrawing mechanism 105 for moving the support frame 3 forward and backward is provided between the support frame 3 and fixed base 71.

However, this massage mechanism is not limited to the chair-type massage machine. It is also possible to employ it as a massage mechanism mounted in a massage machine to be placed or a hand-held massage machine.

The embodiment described in the present specification is merely an example of the invention and is not for the purpose of interpretation of the invention by limitation. In other words, the scope of the invention is defined in claims for patent and the invention includes all modifications included in meanings of the respective claims and equivalents of the claims.

### INDUSTRIAL APPLICABILITY

The present invention can be used suitably as the chair-type massage machine. Moreover, the invention can be used suitably as a massage mechanism that can be employed in the chair-type massage machine, the massage machine to be placed, and the hand-held massage machine.

1. A chair-type massage machine comprising:
a seat portion; a back rest portion provided to a rear portion of the seat portion; an upwardly/downwardly-moving base provided to be movable in an upward/downward direction in the back rest portion; and a mechanism portion provided to a front face of the upwardly/downwardly-moving base through a support frame, wherein
the mechanism portion includes a pair of left and right massage members and a driving mechanism for properly transmitting massage operations to both the massage members,
a lower end portion of the support frame is coupled to the upwardly/downwardly-moving base through a swinging pivot portion such that an upper end side of the support frame is retained for swinging forward and backward, and
a protruding/withdrawing mechanism for moving the support frame forward and backward is provided between the support frame and the upwardly/downwardly-moving base.

2. The chair-type massage machine according to claim 1, wherein each of said massage members is provided with massage heads disposed while leaving a predetermined space between the massage heads in the upward/downward direction.

3. The chair-type massage machine according to claim 1, wherein said protruding/withdrawing mechanism includes: a guide rail formed to protrude forward from the upwardly/downwardly-moving base; a slider which is engaged for sliding forward and backward in the guide rail and on which the support frame is pivoted; an eccentric cam with its outer peripheral face in contact with a rear face portion of the slider; and a protruding/withdrawing driving device for rotating the eccentric cam.

4. The chair-type massage machine according to claim 2, wherein said protruding/withdrawing mechanism includes: a guide rail formed to protrude forward from the upwardly/downwardly-moving base; a slider which is engaged for sliding forward and backward in the guide rail and on which the support frame is pivoted; an eccentric cam with its outer peripheral face in contact with a rear face portion of the slider; and a protruding/withdrawing driving device for rotating the eccentric cam.

5. The chair-type massage machine according to claim 3, wherein
said mechanism portion includes a first operating mechanism for carrying out a kneading massage operation and a second operating mechanism for carrying out a tapping or acupressure massage operation,
said first operating mechanism includes: a first rotary shaft bridged in a lateral direction; a first driving body for driving the first rotary shaft for rotation; a pair of left and right cam members, fixed in vicinities of opposite ends of the first rotary shaft, and having cam faces inclined in opposite directions in the lateral direction; a pair of left and right massage members provided for rotation with respect to each other to the first rotary shaft through the left and right cam members; and bracing members engaged with the respective massage members so as to restrict rotation of both the massage members with rotation of the first rotary shaft and provided to be movable to follow turning of the massage members about the first rotary shaft, and
said second operating mechanism includes: a second rotary shaft provided parallel to said first rotary shaft; a second driving body for driving the second rotary shaft for rotation; cam disks provided in vicinities of opposite ends of the second rotary shaft; and connecting rods having one end portions coupled to the cam disks so as to oscillate as the cam disks rotate eccentrically and the other end portions coupled to the bracing members.

6. A massage mechanism comprising a fixed base and a mechanism portion provided to a front face of the fixed base through a support frame, wherein
the mechanism portion includes a pair of left and right massage members and a driving mechanism for properly transmitting massage operations to both the massage members,
a lower end portion of the support frame is coupled to the fixed base through a swinging pivot portion such that an upper end side of the support frame is retained for swinging forward and backward, and
a protruding/withdrawing mechanism for moving the support frame forward and backward is provided between the support frame and the fixed base.

7. The chair-type massage machine according to claim 4 wherein
said mechanism portion includes a first operating mechanism for carrying out a kneading massage operation and a second operating mechanism for carrying out a tapping or acupressure massage operation,
said first operating mechanism includes: a first rotary shaft bridged in a lateral direction; a first driving body for driving the rotary shaft for rotation; a pair of left and right cam members, fixed in vicinities of opposite ends of the first rotary shaft, and having cam faces inclined in opposite direction in the lateral direction; a pair of left and right massage members provided for rotation with respect to each other to the first rotary shaft through the left and right cam members; and bracing members engaged with the respective massage members so as to restrict rotation of both the massage members with rotation of the first rotary shaft and provided to be movable to follow turning of the massage members about the first rotary shaft, and
said second operating mechanism includes: a second rotary shaft provided parallel to said first rotary shaft; a second driving body for driving the second rotary shaft for rotation; cam disks provided in vicinities to opposite ends of the second rotary shaft; and connecting rods having one end portions coupled to the cam disks so as to oscillate as the cam disks rotate eccentrically and the other end portions coupled to the bracing members.
